(19) United States
(12) Patent Application Publication
(10) Pub. No.: US 2011/0264268 A1
(43) Pub. Date: Oct. 27, 2011

(54) Electrochemical Control Systems And Methods

(75) Inventors: Kevin Anthony Foster, Aylesford (GB); Andreas Ganser, Haldenwang (DE)

(73) Assignee: SIEMENS INDUSTRY, INC., Alpharetta, GA (US)

(21) Appl. No.: 13/090,425

(22) Filed: Apr. 20, 2011

Related U.S. Application Data
(60) Provisional application No. 61/326,946, filed on Apr. 22, 2010.

(51) Int. Cl. B01D 21/30; G05B 21/00; G01N 27/00

(52) U.S. Cl. 700/271; 422/82.01; 210/143

(57) ABSTRACT

Methods for reducing response time of membrane based electrochemical cells. A probe correction factor is calculated based on a percent rate of change in probe signal with time. A staged correction may be applied such that as signal change gets smaller, the effect of the compensation is reduced to prevent over shoot on the calculated residual. Control systems and techniques can regulate or control operations of a water treatment system.

### FIELD OF THE TECHNOLOGY

One or more aspects relate generally to electrochemical analyzers. More particularly, one or more aspects relate to approaches for improving the response time of electrochemical analyzers.

### BACKGROUND

Electrochemical sensors are widely used to determine the concentration of target analytes in a sample or to measure one or more sample parameters. The electrodes of an electrochemical sensor provide a surface at which an oxidation or a reduction reaction occurs. The ionic conduction of an electrolyte solution in contact with the electrodes is typically coupled with the electron conduction of each electrode to provide a complete circuit for a current. Electrochemical sensors may be coupled to a process analyzer or process controller.

Electrochemical sensors, such as pH sensors, ion selective sensors, and redox sensors, are generally equipped with electrical conductors to allow electrical signals to be transmitted to and from electrodes contained within the sensor. An electrochemical sensor used for measuring pH, ORP, or other specific ion concentrations may typically include a specimen sensing ion electrode, a reference cell, and an amplifier that translates a signal into useable information that can be read.

Bare electrode cell sensors and membrane cell sensors are two categories of electrochemical sensors, both typically involving conventional potentiostatic technology. In membrane sensors, a sample typically diffuses through a porous or permeable membrane to a working electrode where a chemical reaction occurs. Considerations in selecting between them for a particular application may include associated reliability, stability, calibration, cost, response time and maintenance.

The various electrochemical analyzers may involve time dependent measurements. For an input step of 100%, a measure of T90 response time is used to indicate the time taken for an output to reach 90% of its final value. The response time for electrochemical based probes can vary from seconds for bare electrode systems to minutes for membrane covered systems. The response time for membrane based probes tends to be slower than bare electrode cells due to the time taken for target species to diffuse through the membrane. For example, while a bare electrode may have a T90 response time of about 45 seconds, a corresponding membrane electrode may have a T90 response time of about three minutes.

When electrochemical probes are used as an element of a control system, for example control of chlorine level in the final treated water from a water works, a fast response time is desirable which makes a bare electrode system the more attractive option. Bare electrode systems can stiffer from limitations, however, in that they may require liquid buffering reagents to control the pH or conductivity of the sample water to ensure that the measurement is stable. This adds additional operational expense through chemical cost. Instead, membrane systems generally include a pre-buffered gel behind the membrane which greatly reduces operational costs. Membrane systems, however, involve additional layers for a sample to migrate through before the sample reaches the electrode leading to response lag time.

### SUMMARY

Aspects relate generally to approaches for improving the time based response of electrochemical analyzers.

In accordance with one or more embodiments, a method of controlling a system may comprise detecting a step change in a process parameter of the system with a membrane-based electrochemical sensor, estimating a residual value of the process parameter of the system based on the step change, determining a correction factor based on the estimated residual value, generating a first control signal based on the correction factor if the detected step change is within a first predetermined range, determining a reduction factor if the step change is within a second predetermined range and generating a second control signal based on the correction factor and the reduction factor if the step change is within the second predetermined value.

In some embodiments, the process parameter corresponds to an oxidation reduction potential of water in the system. The at least one of the first and second control signals may be based on a difference between the estimated residual value of the process parameter and a set point. The correction factor may be based on a rate of change of the value of the process parameter. In some embodiments, the method may further comprise actuating a valve to adjust a value of the process parameter in the water treatment system based on at least one of the first and second control signals. The first control factor may be applied when the detected step change is at least about 10%. The second control signal may be applied when the detected step change is in a range of about 1% to about 10%. In some non-limiting embodiments, no control signal may be generated when the detected step change is less than about 1%.

In accordance with one or more embodiments, a method of reducing response time of an electrochemical sensor may comprise measuring a first probe value, measuring a second probe value after a predetermined time interval has elapsed, determining a rate of signal change between the first and second probe values, applying a first correction factor if the rate of signal change exceeds a threshold value and applying a second correction factor if the rate of signal change is below the threshold value.

In accordance with one or more embodiments, a water treatment system may comprise an electrochemical sensor disposed to measure an operating parameter of the water treatment system and generate a corresponding input signal, a controller configured to receive the input signal, convert the input signal to a corrected input signal, and further configured to generate an output signal based on a difference between the corrected input signal and a set point value and an output device disposed to receive the output signal and adjust the operating parameter in the water treatment system based on the output signal.

In some embodiments, the operating parameter corresponds to an oxidation reduction potential of water in the water treatment system. Thee electrochemical sensor may comprise a membrane covered electrode. The electrochemical sensor may comprise a free or total chlorine probe or a redox probe. In some embodiments, the output signal generated by the controller may be based on a rate of change in the input signal. The output signal may be reduced as a rate of change of input signal is reduced. The controller may apply a reduction factor to the output signal if the rate of change of input signal is below a threshold value. In some embodiments, the electrochemical sensor may be characterized by a T90 response time of less than about 60 seconds.

In accordance with one or more embodiments, a membrane based electrochemical analyzer may have a T90 response time of less than about 60 seconds. The analyzer may be configured to reduce an applied correction factor as the analyzer approaches a residual value.

Still other aspects, embodiments, and advantages of these exemplary aspects and embodiments, are discussed in detail below. Other advantages, novel features and objects will become apparent from the following detailed description when considered in conjunction with the accompanying drawings. Moreover, it is to be understood that both the foregoing information and the following detailed description are merely illustrative examples of various aspects and embodiments, and are intended to provide an overview or framework for understanding the nature and character of the claimed aspects and embodiments.

The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments will be described with reference to the accompanying drawings, in which:

FIG. 1 presents a water treatment control system in accordance with one or more non-limiting embodiments;

FIG. 2 depicts a control algorithm in accordance with one or more non-limiting embodiments;

FIGS. 3 through 11 present modeling and experimental data referenced in the accompanying non-limiting Example 1;

FIG. 12 presents a screen shot relating to a process control function in accordance with one or more non-limiting embodiments; and

FIGS. 13 through 20D present modeling and experimental data referenced in the accompanying non-limiting Example 2.

### DETAILED DESCRIPTION

One or more embodiments may relate, generally, to water and wastewater treatment systems or facilities, and components thereof, as well as to methods, and acts thereof, of treating water and/or wastewater and, in particular, to controlling and control systems of water and/or wastewater treatment systems or facilities.

In accordance with one or more embodiments, a predictive model is disclosed that enables the T90 response time of membrane-based electrochemical sensors to be reduced. In at least some embodiments, the T90 response time may be reduced to less than about one minute. The disclosed embodiments may be broadly applied to any membrane-based electrochemical probe that may benefit from an enhanced response time, such as free chlorine, total chlorine, chlorine dioxide, ozone, potassium permanganate, pH, redox (ORP), fluoride, chlorine-sulfite, conductivity and other ion selective probes. Compliance with regulatory and quality control drivers may be facilitated. Economic savings in terms of wasted chemical expense and risk reduction may result from prevention of under or over dosing. An accuracy of about +/−0.2 ppm is achievable even at the reduced T90 response time. Membrane based probes associated with reduced response times in accordance with one or more embodiments may find use in various control system applications for which they were previously considered unsuitable.

In accordance with one or more embodiments, systems and techniques can be characterized as optimizing control of water treatment systems. The systems and techniques can facilitate identification of one or more conditions which can allow control of the treatment system. The systems and techniques can also be characterized as providing a control system or controller or utilizing a control system that incorporates unique logic techniques. Certain non-limiting systems and techniques can be further characterized as accurately and reliably controlling chlorination and, in some cases, dechlorination systems.

Embodiments may provide one or more controllers or techniques that can regulate the operation of one or more water or aqueous systems including, but not limited to, water and/or wastewater treatment systems. The systems may typically involve adding, to the fluid to be treated, one or more compounds or species. For example, the systems and techniques can control or at least effect control of addition one or more oxidizing compounds, and/or control addition of one or more neutralizing compounds. In accordance with one or more embodiments, operation of a water or wastewater treatment system can be controlled utilizing one or more controllers based on one or more transmitted input signals from one or more input device assemblies. Input device assemblies, such as one or more sensors, may be disposed typically in fluid communication with fluid to be treated such as water or an aqueous medium in the contact chamber, thereby providing a measure of one or more operating parameters of the treatment system. The controller can transmit one or more output signals to one or more output devices which can effect a change to the water treatment system by, for example, introducing a change in a flow rate of one or more added compounds or species, a change in a flow rate of water or wastewater to be treated, and, in some cases, a change in concentration of one or more added compounds or species. Thus, the systems and techniques can effect a change in one or more controlled parameters in response to, or, in some cases, in anticipation of, a change in one or more operating parameters of the water or wastewater treatment system.

Other aqueous systems that can suitably utilize the systems and techniques disclosed include, for example, potable water disinfection systems, systems that utilize breakpoint chlorination techniques such as swimming pool or spa disinfection or treatment systems, industrial water systems, as well as chlorination and dechlorination systems.

In accordance with one or more embodiments, the controller can execute one or more steps or acts. In some cases, one or more embodiments pertinent to computer readable and/or writable media can cause one or more controllers to execute one or more steps or acts.

The one or more compounds can comprise one or more oxidizing agents that can neutralize or at least render inactive or inert at least one undesirable species in the fluid to be treated. In accordance with further embodiments, the compound can comprise one or more species that can affect the performance of the treatments system. For example, the compound can include a pH affecting or altering agent such as, but not limited to acids, bases, and buffers. Further, an output device can comprise a source of an oxidizing agent that can oxidize one or more undesirable species and treat the fluid in treatment system. For example, one or more of output devices can comprise any one of a halogen donor, a free radical species donor, as well as combinations thereof. An output device can comprise a source of a second oxidizing agent and/or one or more neutralizing agents that can react with or otherwise remove or reduce the concentration of one or more target species such as an oxidizing agent from an output device. In other cases, an output device can comprise a source of a reducing agent that reduce or maintain a concentration of a target species to a tolerable or desired level. For example, an output device can comprise a reducing agent that neutralizes the oxidizing agent dispensed from the output device so that the concentration thereof in the discharging wastewater stream satisfies regulated requirements.

A method of controlling addition of a compound to a water treatment system may be provided. The method may comprise measuring a value of a process parameter of the water treatment system and generating a control signal in a control mode based on the value of the process parameter.

In accordance with one or more embodiments, a method of controlling addition of a compound to a water treatment system may be provided. The method can comprise specifying a set point representing an operating condition of the water treatment system, measuring an operating parameter of the water treatment system, and generating a first output signal based on the operating parameter. The output signal may be based on a difference between an input signal and the set point. A tolerance level may also be established.

Various operating parameters may be monitored and controlled. For example, multiple input and output signals may be implemented in accordance with one or more embodiments. Generating any of the output or control signals can utilize or involve at least one of adaptive, flow adjusted lag time, proportional, proportional-integral, proportional-derivative, and proportional-integral-derivative control algorithms.

In accordance with one or more embodiments, a water treatment system can be provided. The water treatment system can comprise an input device disposed to measure an operating parameter of the water treatment system, such as an electrochemical sensor, and generate a corresponding input signal, a controller disposed to receive and analyze the input signal and generate an output signal based on a first difference between the input signal and a first set point value, and an output device disposed to receive the output signal and regulate addition of an agent to the water treatment system.

Electrochemical sensors in accordance with one or more embodiments may be widely used to monitor or control chemical processes. Any membrane-based ion selective electrode capable of measuring a component to be monitored or controlled in a system, such as but not limited to water systems, may be implemented in accordance with one or more embodiments. Free and total chlorine probes, as well as redox probes, may provide a signal for monitoring or control of disinfection of a water system. A pH probe may provide a signal for monitoring of water pH or control of acid or alkali dosing. A fluoride probe may provide a signal for monitoring or control of fluoride dosing to a water system.

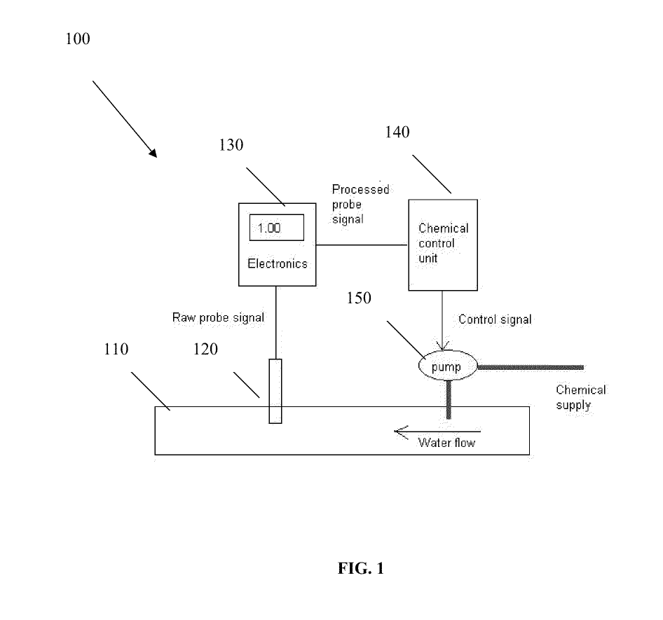

FIG. 1 presents a one or more embodiments of use of disclosed electrochemical sensors in a system application. In a water system 100, an electrochemical probe 110 is located on water feed line 120 to monitor one or more parameters. Probe 110 provides a raw signal to instrumentation, such as analyzer 130. In turn, analyzer 130 provides a processed probe signal to controller 140. Controller 140 then provides one or more control signals to equipment, such as pump 150, which adjusts chemical dosage to water feed line 120.

Electrochemical probe systems generally exhibit responses that can be modeled. For example, a chlorine monitor with bare electrodes will respond in the time it takes the chlorine to flow over the electrode (T1). A membrane chlorine monitor will respond in the time it takes the chlorine to flow over the membrane (T1), plus the time it takes for the chlorine to diffuse through the membrane (T2) plus the time it takes to diffuse through the transport media, such as a pre-buffered gel, to the electrode (T3).

T1 is generally the same for both bare and membrane electrode systems if they are placed in identical sample points. For the membrane probe, the effects of T2 and T3 may be modeled in accordance with one or more embodiments disclosed herein to improve response time. T3, the time to diffuse through the transport media is usually relatively short as the electrode is conventionally fitted flush to the membrane with only a capillary layer of gel between the two. T2, the time to diffuse through the membrane, will be unique for each type of probe, but the same general method for correction may be implemented.

In accordance with one or more embodiments, a membrane probe response may be predicted as though the membrane is not present, or so as to generally reduce the effect of T2 and T3. A membrane probe response time may be improved by correcting for the response lag by calculating the probe response as a function of change during a given time step. In general, assuming that a membrane probe is subjected to a step change in signal, the disclosed correction approach may be based upon two raw signals from a probe taken over a predetermined time period. These signals may be passed to an electronics module configured to process the difference between the two signals and predict a final response of the probe almost equivalent to that of a bare electrode system.

In accordance with one or more embodiments, a signal correction factor for an electrochemical probe may be determined based on modeling the response of the electrochemical probe. The actual probe response to a predetermined step change value as a function of time may be determined and plotted. The predicted response may be modeled based on the actual probe response. Some nonlimiting electrochemical probes may exhibit an exponential response to residual as a function of time. A modeled response curve may be normalized, such as over a range of 0 to 1. The fit of a normalized, predicted response curve may be evaluated by factoring it by the final residual value and comparing it to an actual probe response curve.

In accordance with one or more embodiments, once the response of an electrochemical probe as a function of time is modeled, it can then be used to predict the response to any step change in the future.

In accordance with one or more embodiments, a modeled response for an electrochemical probe may be used to obtain a percent rate of change in probe signal with time for a step change in residual according to Equation 1:

$$\% Rate of change = \frac{Current signal - previous signal}{Previous signal} \times 100 \qquad Eq . 1$$

The rate of change may then be used to calculate a probe correction factor at each time step according to Equation 2 to enable the actual step change in residual to be calculated:

Correction factor=rate of change of residual/final residual Eq. 2

If plotted, the slope yields the probe correction factor as a function of rate of change. In general, the slope may be viewed as the probe correction factor for rate of change of probe signal required to give the correct residual value. This may be applied as a basic correction to correct the probe response according to Equation 3:

Corrected response=current response+(rate of change of probe*slope) Eq. 3

This basic correction may be used widely but if the signal has any noise in it, spiking may result. This may lead to over or under correction which can result in oscillation as the signal approaches the final residual value. Thus, in at least some embodiments, a self-reducing compensation involving a reducing factor may be selectively applied such that as the signal change gets smaller, the effect of the compensation is reduced to prevent overshoot or undershoot on the calculated residual, such as deviation around the final residual value. In this way, the extent of the correction may be reduced as the rate of change of signal gets smaller.

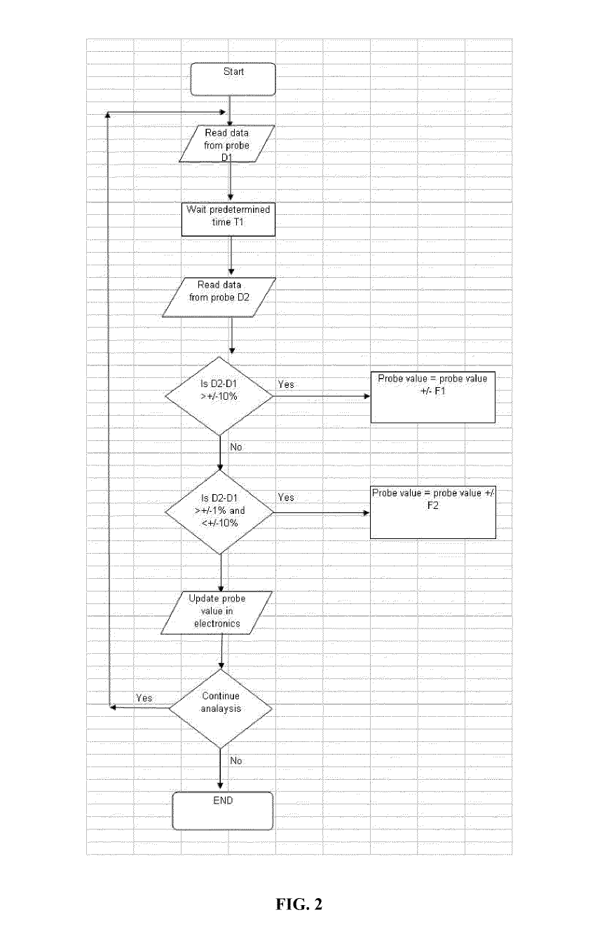

In accordance with one or more embodiments, an electrochemical membrane probe may be connected to an electronics module capable of storing probe values. With reference to FIG. 2, an initial measurement of the probe value may be taken and recorded in the electronics module. A predetermined time interval may be allowed to elapse and then a second measurement of the probe value may be taken and recorded in the electronics module. The difference between the two measurements over the time period, rate of signal change (RSG) may then be used to determine the extent of correction to be applied.

With further reference to FIG. 2, if the RSG is greater than a predetermined value, then a correction factor F1 may be applied in accordance with one or more embodiments. Any predetermined value may be selected depending on the application. In some non-limiting embodiments, a predetermined value of about 10% may be implemented, F1 may be an initial enhancement of the signal and may provide the greater part of the correction factor. If the RSG is in predetermined range, then a correction factor F2 may be applied. Any predetermined range may be selected depending on the application. In some non-limiting embodiments, a predetermined range of about 1% to about 10% may be implemented. F2 may be a secondary correction factor which is a self reducing correction. If the RSG is less than a predetermined value, no change may be made to the current reading. Any predetermined value may be selected depending on the application. In some non-limiting embodiments, a predetermined value of about 1% may be implemented. This staged correction approach, involving initial coarse signal adjustment and subsequent fine tuning, may prevent overshoot and signal oscillation as the signal approaches its final stable value.

In accordance with one or more embodiments, various correction approaches may be used to reduce the response time of an electrochemical sensor. A first stage correction may be used for correction while a signal is changing rapidly, such as above a threshold level. In some non-limiting embodiments, the first stage may be implemented if the signal is changing by at least 10%. The first stage correction may serve to increase the signal proportionally to the measured response of the probe over a given time base. In the first stage, the corrected residual may be expressed as:

$$Corrected Residual = R C + \frac{S G C}{T B} * F A C 1 \qquad Eq . 4$$

SGC is defined as the change of signal over a given time base, and has a value greater than 10% of the initial electrochemical measurement in the first correction stage. TB is defined as the time base or measuring interval, and has a value between 1 and 60 seconds. RC is the recorded residual or live reading of the electrochemical probe. FAC1 is the correction factor for the type of electrochemical measurement to which the correction is being applied. FAC1 may be determined in accordance with the derivation above. In general, FAC1 is a factor between 1 and 1000 with no units and may be dependent upon the type of probe being used for analysis. In some non-limiting embodiments FAC1 may be between about 1 and 100. For a chlorine membrane probe, FAC1 may have a value of about 10 to 30, for example about 21.6 in some non-limiting embodiments such as that presented in the accompanying Example.

In accordance with one or more embodiments, a second stage corrected residual may be applied when the signal is changing within a predetermined range, for example, by more than about 1% and but less than about 10%. The second stage may involve applying a self reducing compensation wherein as the signal change gets smaller the effect of the compensation is reduced to prevent over shoot or periodic oscillation on the calculated residual. In the second stage, the corrected residual may be expressed as:

$$Corrected Residual = R C + \frac{S G C}{T B} * F A C 2 * R F \qquad Eq . 5$$

RF is a reducing factor that is applied to the probe factor FAC2. The purpose is to reduce the extent of the correction as the rate of change of signal gets smaller.

RF=(RF1−(OF1*ê^{(0.01}*^{(0.1/SGC)}) Eq. 6

In Equations 5 and 6, SGC is defined as the change of signal over a given time base. TB is defined as the time base or measuring interval, and has a value of 1 to 60 seconds. RC is the recorded residual or the live reading of the electrochemical probe. FAC2 is the correction factor for the type of electrochemical measurement to which the correction is being applied. FAC2 may be determined in accordance with the derivation above. In general, FAC2 is a factor between 1 and 1000 with no units. For a chlorine membrane probe, FAC2 may have a value of about 21.6 in some non-limiting embodiments such as that presented in the accompanying Example. RF is the overall reduction factor applied to FAC2. RF1 is the first reduction factor and is defined as 1 to 1000. For a chlorine membrane probe this may be set at 7.5 in some non-limiting embodiments. OF1 is the offset factor and may typically be set as OF1=RF1−1 in some non-limiting embodiments. The defined range is 1 to 1000. For a chlorine membrane probe, OF1 may be set to 6.5 in some non-limiting embodiments.

In accordance with one or more embodiments, when the signal is changing below a predetermined limit, for example, by about 1% or less, compensation may or may not be used. In at least one embodiment, no compensation is applied when the signal is changing below about 1%.

In accordance with one or more embodiments, the T90 response time of a membrane-based electrochemical probe may be variable. In some embodiments, the T90 response time may vary with the step change. In certain nonlimiting embodiments, higher step changes may be associated with faster T90 response times such that the lower the rate of change, the higher the T90 response time. As such, a variable correction factor may be applied over a range of signal changes rather than a static model. In some embodiments, a correction algorithm may be more active for signal jumps where the T90 response time is long, and less active when the T90 response time is relatively short.

In accordance with one or more embodiments, a maximum rate of change may be directly proportional to the step change. As such, the change in T90 response time may be dependent on the rate of change. A corrected residual may be determined knowing the actual T90 response time given by the rate of change.

In accordance with one or more embodiments, T90 correction may be inactive for small rates of change. This may be referred to generally as stage 1 correction. If the T90 time is very high, the rate of change in a given time base may be very small. As such, a T90 correction facto would be very high which may undesirably lead to extreme overshoots of a corrected residual. The point at which T90 correction may be deactivated may be experimentally determined. In some nonlimiting embodiments involving a chlorine membrane probe, the switch-off point may be less than about 0.25 mg/l. Noise reduction may be integrated when T90 correction is inactive.

In a second stage correction in accordance with one or more embodiments, a correction factor may be constant for all rates of change. The T90 correction may be switched off for small rates of change.

In a third stage correction in accordance with one or more embodiments, T90 correction may be activated as the rate of change gets greater. A maximum correction factor may be determined experimentally.

In some embodiments, a filter may be used in the algorithm to evaluate the signal change over time with noise reduction.

In accordance with one or more embodiments, a system, such as a water treatment system, may include one or more sensors in communication with a controller to facilitate monitoring and regulating the operating conditions of the system, including its components. Various types of sensors may be strategically positioned within the system to monitor one or more operational parameters and/or operating conditions of the system. For example, sensors for temperature, pH, pressure drop, and flow rate may be incorporated at different points to facilitate system monitoring. More specifically, an electrochemical sensor may be configured to detect a parameter. Information collected by an electrochemical sensor may signal that system maintenance is required, or that one or more operational parameters should be adjusted for optimization and/or to meet established requirements.

In accordance with one or more embodiments, data from various sensors may be communicated to the controller to facilitate adjusting or regulating at least one operating parameter of the system or a component thereof, such as, but not limited to, actuating valves and pumps. The controller may be in communication with various valves and pumps of the system and may provide control signals thereto. For example, an electrochemical sensor may provide a raw signal to an analyzer that provides a processed signal to a controller. The controller may then send a control signal to a valve or pump based on the processed signal, such as to adjust a flow rate of one or more reagents to the system. Other control regimes may be implemented by one skilled in the art given the benefit of this disclosure.

Embodiments are not limited to any particular type of sensing device and can utilize one or more sensing devices and/or one or more types of sensor design such as, but not limited to, electrochemical devices, membrane-based devices, as well as ultrasonic-based sensor for sensing chlorine, combined chlorine, bromine, hypochlorus acid, chlorine dioxide species concentration, and/or pH. Thus, sensor or measurement devices such as amperometric, oxidation reduction potential, tri-amperometric and membrane devices can be utilized in the systems and techniques according to one or more embodiments.

The output signal of the controllers can control, actuate, and/or energize devices such as pumps, valves, and motors. The controller output signal may be generated to influence the feed rate of oxidizers such as chlorine, hypochlorite, bromine and other process chemicals. In addition the controller output signal may be configured to influence the feed rate of reducing agents such as sulfur dioxide, sodium bisulfite and other process chemicals.

The controllers can include one or more processor and can, for example, comprise a computer. One or more embodiments may include, among other components, a plurality of known components such as one or more processors, memory systems, disk storage systems, network interfaces, and busses or other internal communication links interconnecting the various components. One or more of the components of the systems may reside on a single control system e.g., a single microprocessor, or one or more components may reside on separate, discrete systems, e.g. a network of computers. Further, one or more components of the systems may be distributed or represented across multiple control systems. Different aspects or portions of the components of the system may reside or be represented in different areas of memory (e.g., RAM, ROM, disk, etc.) on the control system. In some cases, different portions of the control system may be present or utilized in one or more locations remotely positioned from each other and/or the water system. Thus, for each of the one or more systems that can include one or more components of the systems, each of the systems and/or components thereof may reside or be utilized in one or more locations.

The methods, acts thereof, and various embodiments and variations of the methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof. The computer-readable medium on which such instructions are stored may reside on one or more of the components of system described above, and may be distributed across one or more of such components.

The computer-readable medium may be transportable such that the instructions stored thereon can be loaded onto any computer system resource to implement the aspects discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects.

Although several of the steps or acts described herein have been described in relation to being implemented on a computer system or stored on a computer-readable medium, aspects are not limited as such, as steps or acts may be implemented without use of a computer by, for example, a person.

Various embodiments may be implemented on one or more computer systems. These computer systems may be, for example, general-purpose computers such as those based on any one or more PENTIUM® processors available from Intel Corporation, Santa Clara, Calif.; PowerPC™ processors available from Motorola, Inc., Schaumburg, Ill.; UltraSPARC® processors available from Sun Microsystems, Inc., Santa Clara, Calif.; PA-RISC architecture based processors available from, for example, Hewlett-Packard Corporation, Palo Alto, Calif.; or any other type of processor. It should be appreciated that one or more of any type computer system may be used to control one or more wastewater treatment systems in one or more control modes according to various embodiments. Further, the software design system may be located on a single computer or may be distributed among a plurality of computers attached by, for example, a communications system, or network.

Further, a general-purpose computer system according to one embodiment can be configured to perform to control one or more wastewater treatment systems in one or more control modes. It should be appreciated that the system may perform other functions, including, for example, monitor pH, monitor material inventories, create, and/or send reports, including, for example, status reports or even alarm reports, to one or more stations, individuals, or organizations. Embodiments are not limited to having any particular function or set of functions described above.

For example, various aspects may be implemented as specialized software, embodied, for example, in a computer-readable medium, executing in a general-purpose computer system. The computer system may include a processor connected to one or more memory devices, such as a disk drive, flash drive, memory, or other device for storing data, which can be used for storing programs and data during operation. Components of the computer system may be coupled by one or more interconnection mechanisms, which may include one or more busses, e.g., between components that are integrated within a same machine, and/or a network, e.g., between components that reside on separate discrete machines. The interconnection mechanism preferably enables communications, e.g., data, instructions, to be exchanged between system components of the computer system or even the controller, which can utilize wired or by wireless communication techniques. The computer system can also include one or more input devices such as, but not limited to keyboards, mouse, trackballs, microphones, touch screens, as well as one or more output devices such as, but not limited to, printing devices, display screens, alarm indicators, and speakers. In addition, the computer system may contain one or more interfaces that connect the computer system to a communication network, in addition or as an alternative to the network that may be formed by one or more of the components of system.

The systems can include one or more computer readable and writeable nonvolatile recording media in which signals can be stored that define a program or algorithm to be executed by the processor or information stored on or in the medium to be processed by the program. The medium may have various forms and can be utilized as, for example, a disk, or flash memory. Typically, in operation, the processor causes data to be read from the nonvolatile recording medium into another memory structure that can allow for faster access to the information by the processor than does the medium. This memory can be a volatile, random access memory such as a dynamic random access memory (DRAM) or static memory (SRAM). It may be located in a storage system or in a memory system in communication with one or more processors. In some cases, the processor can manipulate the data within one or more integrated circuit memory structures and can then copy the data to the medium after processing is completed. A variety of mechanisms can be utilized to manage data movement between the medium and the integrated circuit memory element. Further, various types of memory structures or subsystems can be utilized and embodiments are not limited to a particular memory system or storage system.

The controllers may utilize and/or include specially-programmed, special-purpose hardware including, for example, application-specific integrated circuit (ASIC) devices. Various aspects may be implemented in software, hardware or firmware, or any combination thereof. Further, such methods, acts, systems, system elements and components thereof may be implemented as part of the controller described herein or as an independent component thereof.

The various systems may comprise one or more general-purpose computer system that is programmable using any suitable high-level computer programming language. The controllers may be also implemented using specially programmed, special purpose hardware. The controllers can utilize one or more processors or microprocessors which are typically commercially available processors and can be, for example, PENTIUM® processors available from Intel Corporation, Santa Clara, Calif. Other commercially available processors can be utilized including any that can employ one or more operating systems which may be, for example, WINDOWS® 95, WINDOWS® 98, WINDOWS® NT, WINDOWS® 2000 (WINDOWS® ME), WINDOWS® XP® or WINDOWS®7 operating systems, each available from Microsoft Corporation, MAC® OS System X® available from Apple Computer, Solaris operating system available from Sun Microsystems, or UNIX operating system available from various sources such as Linux. Other operating systems may be used, and the present embodiments are not limited to any particular implementation.

Typically, the processor and operating system together define a computer platform for which application programs in high-level programming languages are written. It should be understood that embodiments are not limited to a particular computer system platform, processor, operating system, or network. Also, embodiments are not limited to a specific programming language or computer system. Further, it should be appreciated that other appropriate programming languages and other appropriate computer systems could also be used.

One or more portions of the systems may be distributed across one or more computers (not shown) coupled to a communications network. These computer systems may also be general-purpose computer systems. For example, various aspects may be distributed among one or more computer systems configured to provide a service (e.g., servers) to one or more client computers, or to perform an overall task as part of a distributed system. For example, various aspects may be performed on a client-server system that includes components distributed among one or more server systems that perform various functions according to various embodiments. These components may be executable, intermediate, e.g., IL, or interpreted, e.g., Java, code which communicate over a communication network, e.g., the Internet, using a communication protocol, e.g., TCP/IP. Thus, one or more components may be located remotely from the treatment system and be in communication therewith through any one or more techniques including, for example, by radio, network, virtual network, or even through the Internet.

It should be appreciated that embodiments are not limited to executing on any particular system or group of systems, and are not limited to any particular distributed architecture, network, or communication protocol.

Various embodiments may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects may be implemented in a non-programmed environment (e.g., documents created in HTML, XML or other format that, when viewed in a window of a browser program, render aspects of a graphical-user interface (GUI), or perform other functions). Various aspects may be implemented as programmed or non-programmed elements, or combinations thereof.

For example, the above-discussed functionality for reducing response time can be implemented using hardware, software or a combination thereof. When implemented in software, the software code can be executed on any suitable processor. It should further be appreciated that any single component or collection of multiple components of the computer system that perform the functions described above can be generically considered as one or more controllers that control the above-discussed functions. The one or more controllers can be implemented in numerous ways, such as with dedicated hardware, or using a processor that is programmed using microcode or software to perform the functions recited above.

The above-described embodiments can be implemented in any of numerous ways. In this respect, one implementation of the embodiments comprises at least one computer-readable medium (e.g., a computer memory, a floppy disk, a compact disk, a tape, flash memory, etc.) encoded with a computer program (i.e., a plurality of instructions), which, when executed on a processor, performs the above-discussed functions of the embodiments. The computer-readable medium can be transportable such that the program stored thereon can be loaded onto any computer system resource to implement the aspects discussed herein. In addition, it should be appreciated that the reference to a computer program which, when executed, performs the above-discussed functions, is not limited to an application program running on the host computer. Rather, the term computer program is used herein in a generic sense to reference any type of computer code, e.g., software or microcode, which can be employed to program a processor to implement the above-discussed aspects.

In some aspects, an algorithm in accordance with one or more embodiments may be implemented in a controller or a PLC system. A membrane-based probe may convey data to a controller housing the algorithm and the controller may then interpret the data and provide a control signal based on the data. In other embodiments, a membrane-based probe in accordance with one or more embodiments may include head electronics implementing the algorithm. The probe may interpret data with an onboard processor and communicate processed information to a controller. The processor may therefore be either remote or local with respect to the membrane-based probe.

In accordance with one or more embodiments, functionality may be implemented such that a user or operator may selectively activate a speed-up function associated with an electrochemical sensor to decrease its response time in accordance with various systems and methods disclosed herein.

Modification of existing electrochemical cells and analyzers, or components thereof, may be performed so as to retrofit them to implement the techniques of the disclosed embodiments.

The function and advantages of these and other embodiments will be more fully understood from the following examples. These examples are intended to be illustrative in nature and are not to be considered as limiting the scope of the systems and methods discussed herein.

### Example 1

Correction in accordance with one or more embodiments disclosed herein was applied to a FCl™ free chlorine measurement sensor commercially available from Siemens Water Technologies. The FCl probe consisted of a membrane covered electrode system.

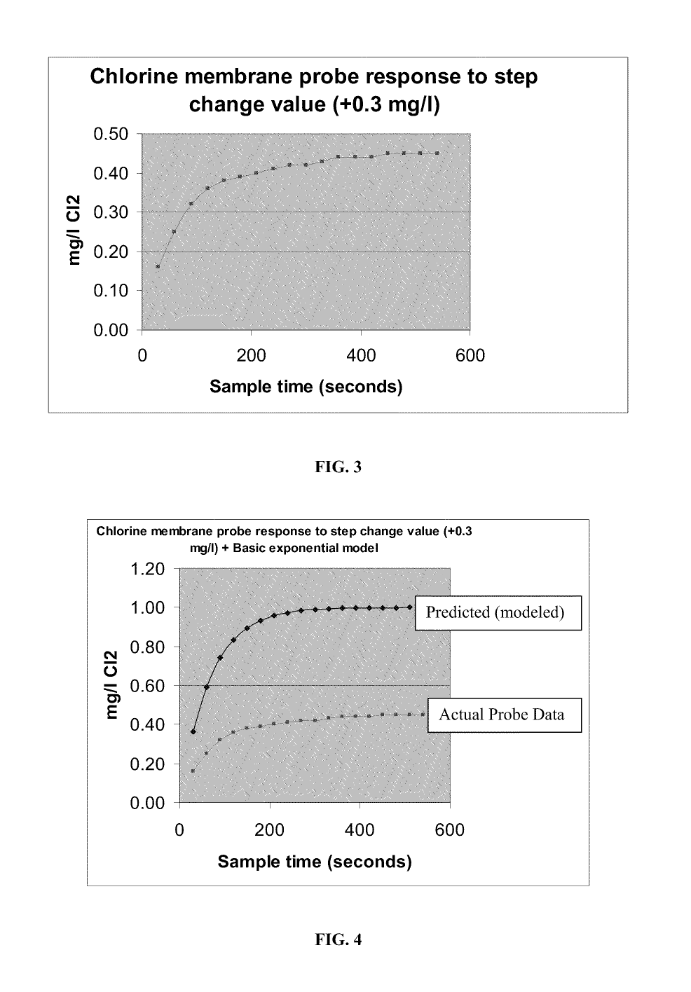

FIG. 3 presents a graph showing a typical FCl response to a step change in chlorine residual. As illustrated, the probe has an exponential response to residual as a function of time. The FCl probe response was modeled as represented by Equation 7:

Response=(1−(1*ê^{(-FR*(MT/TB))}) Eq. 7

where FR is the final residual, MT is the time of measurement and TB is the measurement time base.
Inserting the relevant parameters for the data presented in FIG. 3 relating to an applied step change value of +0.3 mg/l from 0.15 mg/l and a time base (TB) of 30 seconds, the applicable probe model is represented by Equation 8:

Response=(1−(1*ê^{(-0.45*(MT/30)}) Eq. 8

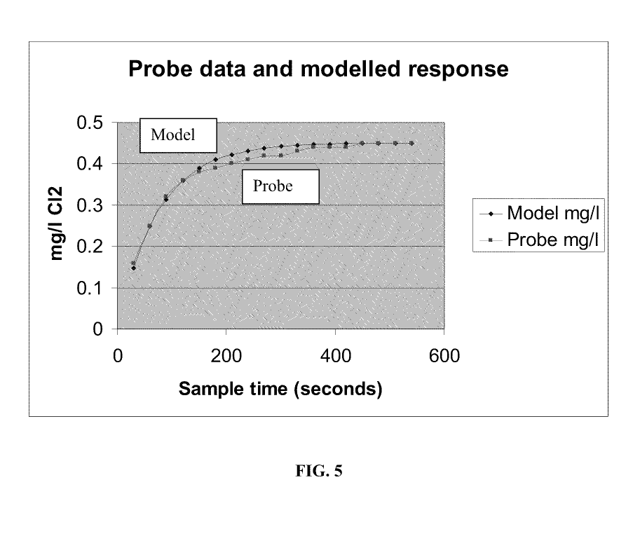

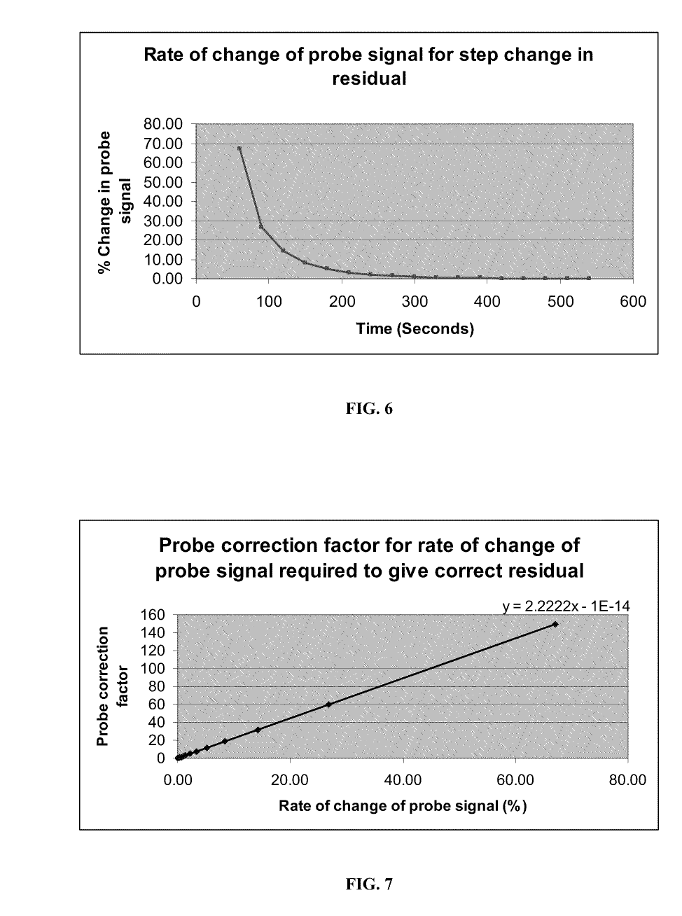

The model describes a basic response curve for the FCl probe normalized over a 0 to 1 range. FIG. 4 compares this basic exponential model to the actual FCl data of FIG. 3.

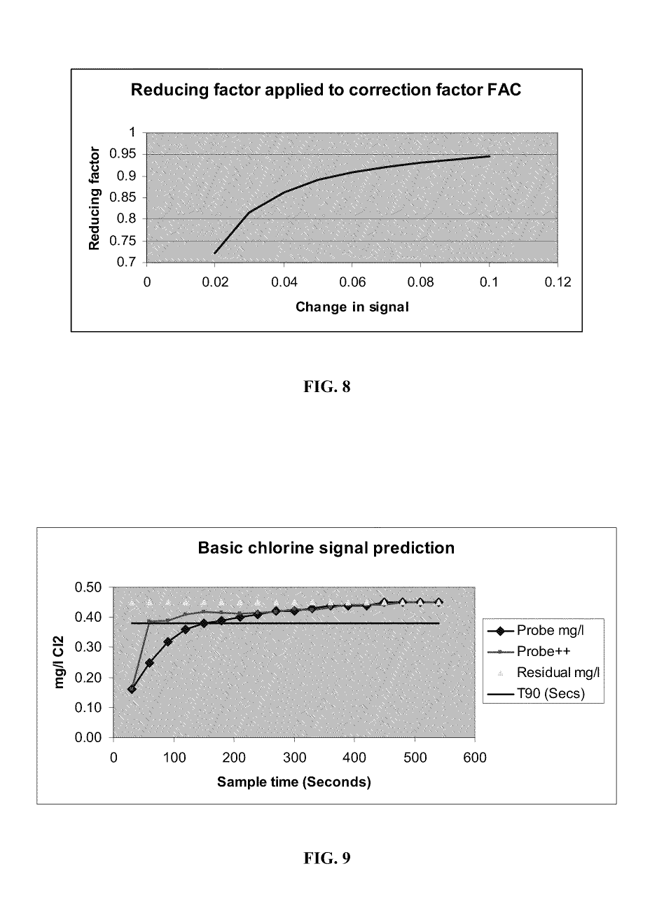

The basic exponential curve model (Eq. 8) can be fitted to the actual probe curve by factoring it by the final residual value (FR), in this example 0.45, according to Equation 9 and FIG. 6 illustrates the fit of the model:

Response=(1−(1*ê^{(-FR*(MT/TB))})*FR Eq. 9

Using this model, a percent rate of change in probe signal with time for a step change in residual was obtained as illustrated in FIG. 6.

A probe correction factor at each time step was then determined from the percent rate of change to enable the actual step change in residual to be calculated.

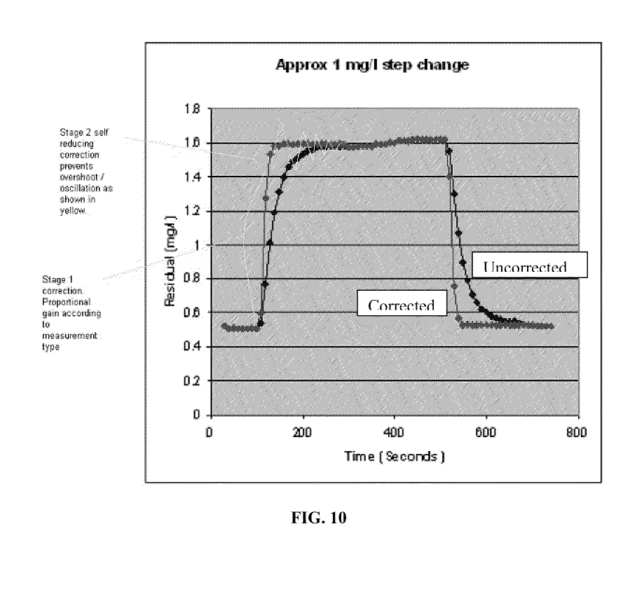

From the plot presented in FIG. 7, the slope which yields the probe correction factor as a function of rate of change was obtained. The data shows that this correction slope is 2.22 for a 30 second logging interval.

A staged correction algorithm was then built in accordance with one or more embodiments disclosed herein:

Corrected residual—Stage 1 used to correct while the signal is changing rapidly. i.e. as long as the signal is changing by at least 10%

$$Corrected residual ( stage 1 ) = R C + \frac{S G C}{T B} * 21.6 \qquad Eq . 10$$

Corrected residual—Stage 2 used when the signal is changing by more than 1% and less than 10% a self reducing compensation is applied. i.e. as the signal change gets smaller the effect of the compensation is reduced to prevent over shoot on the calculated residual

$$= R C + \frac{S G C}{T B} * 21.6 ( 7.5 - ( 6.5 * {e}^{\hat{} ( 0.01 * ( 0.1 / SGC ) )} ) \qquad Eq . 11$$

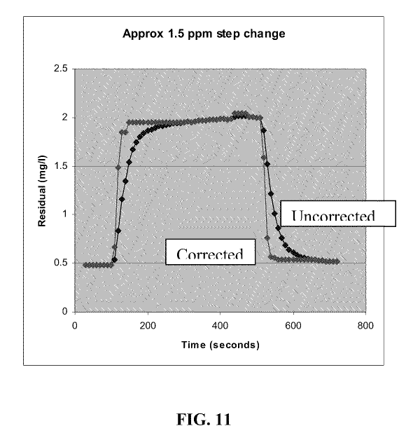

FIG. 8 illustrates the reducing factor applied to the correction factor as a function of change in signal.

When the signal is changing by 1% or less, no compensation is used in the algorithm.

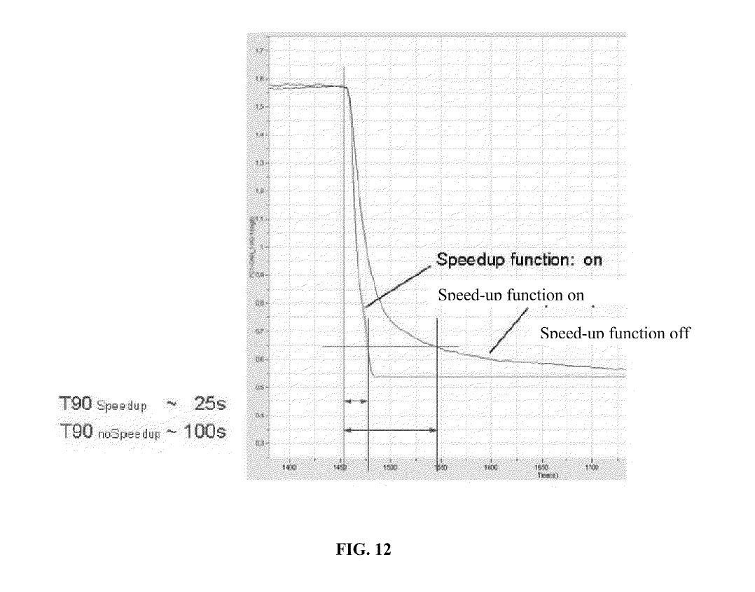

FIG. 9 illustrates the reduced response time of the corrected probe (probe ++) compared to the uncorrected probe in terms of registering the residual value. The corrected probe is associated with a lower T90 response time than the uncorrected probe.

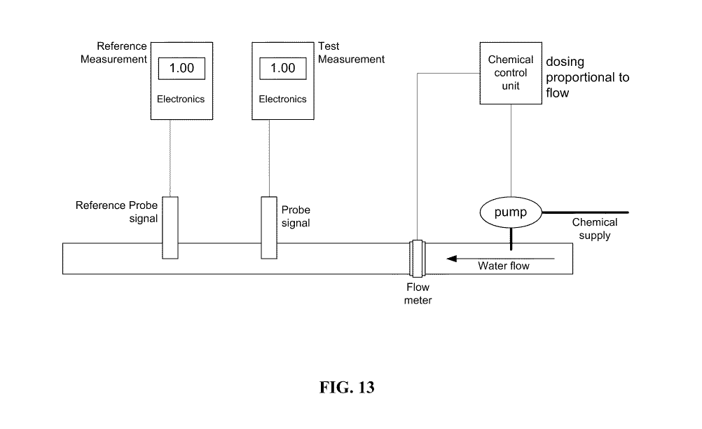

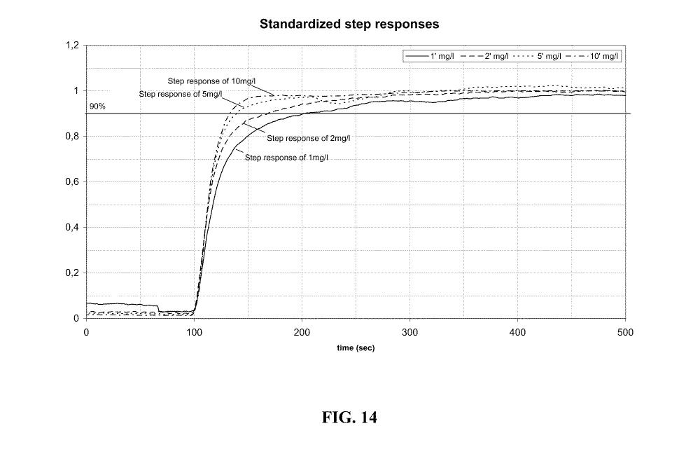

The derived algorithm was then applied to the FCl probe for various step changes. The results of this correction relative to the original residual measurement are shown in FIGS. 10 and 11 for step changes of 1 mg/l and 1.5 mg/l respectively. The uncompensated measurements are shown in blue and the compensated measurements are shown in red. In each case, the data interval implemented was 10 seconds. As illustrated, the T90 response time for the uncompensated probes was approximately 90 seconds while the T90 response time for the compensated probe was approximately 20 seconds in both cases.

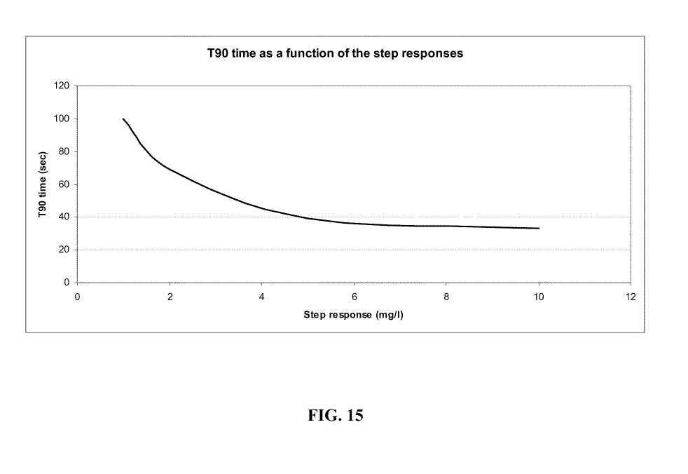

FIG. 12 presents a sample of a screen shot from a control system implementing a speed-up function in accordance with one or more embodiments that may be selectively activated or deactivated by an operator. The screen shot indicates a reduced T90 response time associated with the activated speed-up function.

### Example 2

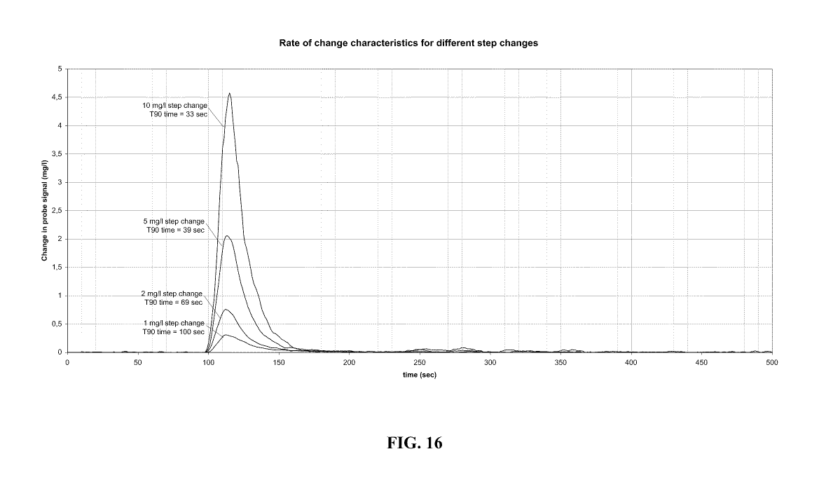

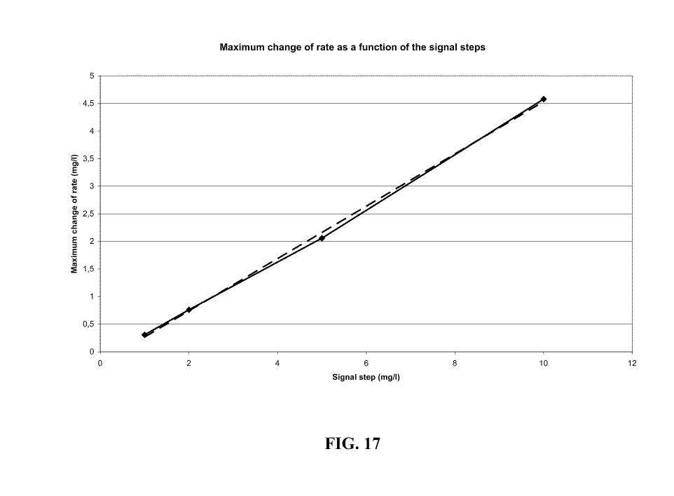

In a water disinfection system, an electrochemical membrane probe was positioned on a water feed line to monitor a chlorine value. A bare electrode probe, known to have a relatively faster response time, was also installed on the feed line as a point of reference as illustrated in the experimental setup of FIG. 13. Thus, the same water was introduced to both probes. For determination of the response time, the chlorine concentration in the water feed was changed from 0 to different values. To stabilize the concentration, a pump was generally controlled proportional to the water flow. Other process conditions including temperature and pH-value were held constant during the tests such that sensor specific dependencies would not affect the probe readings. FIG. 14 presents standardized step responses at 1 mg/1, 2 mg/1, 5 mg/l and 10 mg/l.

Measurements of the response time of different step responses indicated that the T90 time differed with the height of the step response as illustrated in the table below in which the faster response times are generally associated with higher step responses:

| | 1 mg/l Step | 2 mg/l Step | 5 mg/l Step | 10 mg/l Step |
|---|---|---|---|---|
| T90 time | 100 sec | 69 sec | 39 sec | 33 sec |

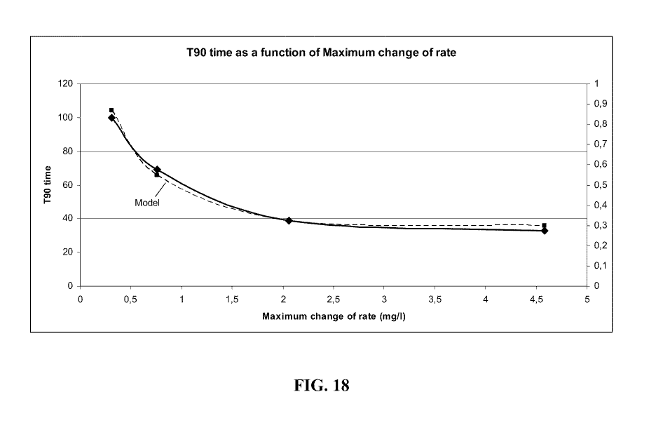

FIG. 15 presents the T90 response time as a function of step response. As illustrated, the T90 response times is not constant for any given membrane probe. Thus, a variable correction factor may be more appropriate than a static model over a wide range of signal changes. An algorithm was implemented in which a greater correction factor was applied for signal jumps associated with a longer T90 response time, and a lesser correction factor was applied for signal jumps associated with a shorter T90 response time.

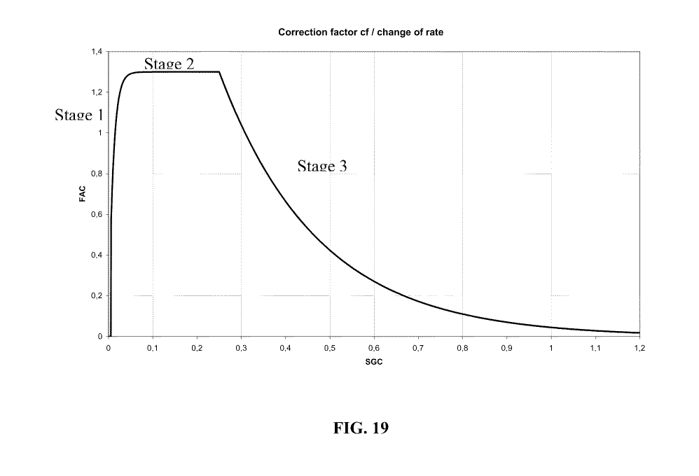

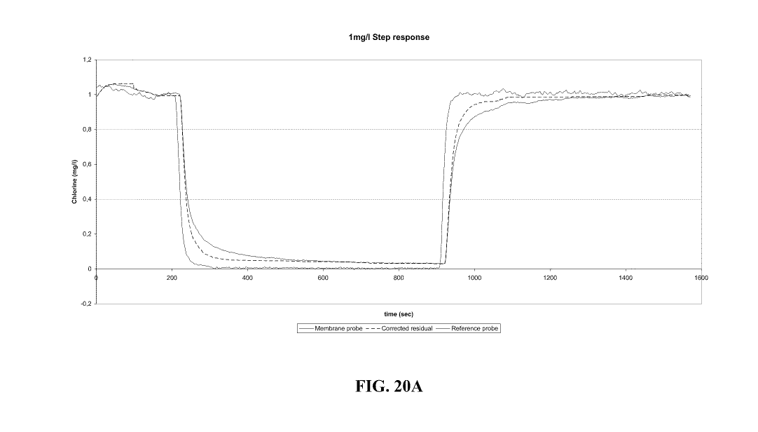

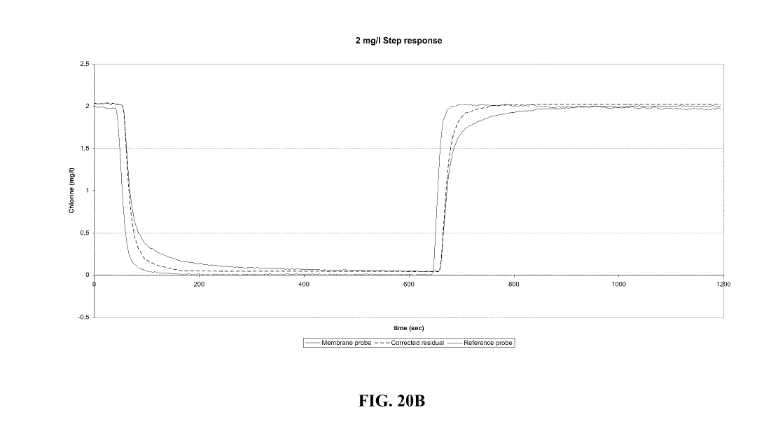

FIG. 16 presents a graph illustrating the typical rate of change for the different step changes with a time base of 10 seconds. In general, the lower rate of change is associated with a higher T90 response time. FIG. 17 plots the maximum rate of change for each step change and the data indicates a direct proportional relationship between the maximum rate change and the step change. In view of this proportional relationship, the change in T90 response time as a function of rate of change may be plotted as illustrated in FIG. 18. Mathematical modelling of the FIG. 18 curve of T90 response time for each step change as a function of the maximum rate change indicated the following relationship:

T90 correction factor=(DF1*ê(DF2*change of rate)) Eq. 12

where the factors DF1 and DF2 depends on the behaviour of the T90 time changes and must be determined experimentally. The correction factor may then be more accurately depending on the actual T90 response time given by any change of rate. The corrected residual may then be expressed as:

Corrected Residual=RC+SGC/TB*FAC1*T90corr Eq. 13

If the T90 time is very high, the rate of changes in a given time base are very small. So the T90 correction factor is expected to be very high. This causes extreme overshoots of the corrected Residual. Therefore the T90 correction must be switched off for small change of rates. The point where the T90 correction must be switched off must be determined experimentally. In case of the chlorine membrane probe used in this Example 2, the switch off point was a less than about 0.25 mg/l.

With the addition of the T90 correction factor, the speed-up algorithm may be applied in different stages. In the current Example 2, three stages were implemented.

Stage 1 correction was applied to the state where the correction factor is reduced to zero by an exponential function. The T90 correction is switched off, because of small rate of changes

Corrected Residual=RC+SGC/TB*FAC2*RF Eq. 14

where RF is a reducing factor.

In this stage 1, noise reduction was also integrated, because of the reduction factor which reduces the correction factor to zero.

Stage 2 correction was applied where the correction factor is generally constant for all rates of changes. The T90 correction must be switched off, because off small rate of changes.

Corrected Residual=RC+SGC/TB*FAC1 Eq. 15

If the formula for the reducing RF is modified, Stage 1 and Stage 2 may be expressed with only one formula:

Corrected Residual=RC+SGC/TB*FAC1*RF Eq. 16

with

RF=(1−(ê−(|SGC|/TC))) Eq. 17

TC is the time constant for the reducing curve. If the SGC is 5 * TC the correction factor has 99% of its maximum value.

Stage 3 correction was applied where the rate of change gets greater and the T90 correction is switched on.

Corrected Residual=RC+SGC/TB*FAC1*T90corr Eq. 18

with

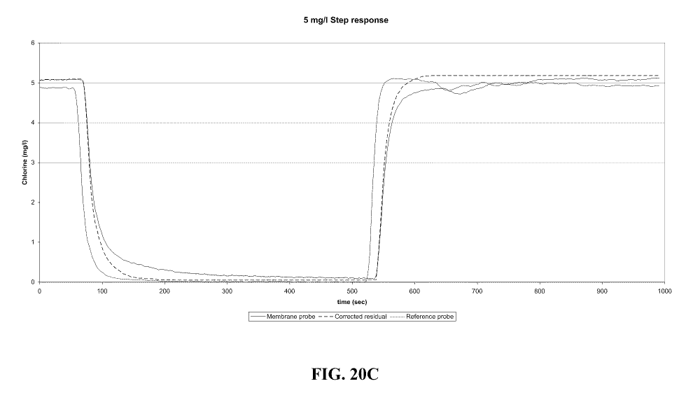

T90corr=(DF1*ê(−DF2*|SGC|−SOP) Eq. 19

where SOP is the switch off point.
FAC1 is the maximum correction factor and must be appointed by the dedicated T90 time at the switch off point.
FIG. 19 illustrates the correction factor as a function of rate of change with reference to Stage 1, Stage 2, and Stage 3 as implemented by the experimental membrane-based probe.
A further improvement of the speed up algorithm is to evaluate the signal change over time by a simple filter.

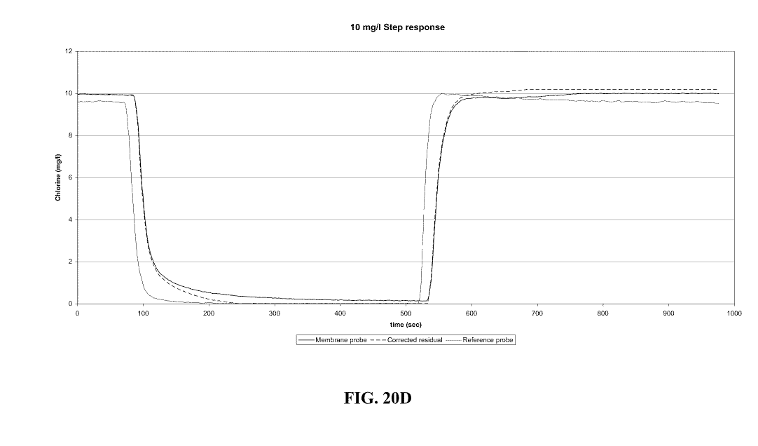

SGC=old SGC value*(0.9)+new SGC value*(1−0.9) Eq. 20

where the value 0.9 defines the strength of the filter.
With filtering, the SGC value noise of the speed-up algorithm may be reduced or eliminated.
FIGS. 20A-20D illustrate step responses associated with the implemented algorithm for different concentrations. As illustrated, the corrected residual approaches the reference probe value in terms of T90 response time.

Having now described some illustrative embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

It is to be appreciated that embodiments of the devices, systems and methods discussed herein are not limited in application to the details of construction and the arrangement of components set forth in the following description or illustrated in the accompanying drawings. The devices, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of controlling a system, comprising:
detecting a step change in a process parameter of the system with a membrane-based electrochemical sensor;
estimating a residual value of the process parameter of the system based on the step change;
determining a correction factor based on the estimated residual value;
generating a first control signal based on the correction factor if the detected step change is within a first predetermined range;
determining a reduction factor if the step change is within a second predetermined range; and
generating a second control signal based on the correction factor and the reduction factor if the step change is within the second predetermined value.

2. The method of claim 1, wherein the process parameter corresponds to an oxidation reduction potential of water in the system.

3. The method of claim 1, wherein at least one of the first and second control signals is based on a difference between the estimated residual value of the process parameter and a set point.

4. The method of claim 1, wherein the correction factor is based on a rate of change of the value of the process parameter.

5. The method of claim 1, further comprising actuating a valve to adjust a value of the process parameter in the system based on at least one of the first and second control signals.

6. The method of claim 1, wherein the first control factor is applied when the detected step change is at least about 10%.

7. The method of claim 6, wherein the second control signal is applied when the detected step change is in a range of about 1% to about 10%.

8. The method of claim 7, wherein no control signal is generated when the detected step change is less than about 1%.

9. A method of reducing response time of an electrochemical sensor, comprising:
measuring a first probe value;
measuring a second probe value after a predetermined time interval has elapsed;
determining a rate of signal change between the first and second probe values;
applying a first correction factor if the rate of signal change exceeds a threshold value; and
applying a second correction factor if the rate of signal change is below the threshold value.

10. A water treatment system, comprising:
an electrochemical sensor disposed to measure an operating parameter of the water treatment system and generate a corresponding input signal;
a controller configured to receive the input signal, convert the input signal to a corrected input signal, and further configured to generate an output signal based on a difference between the corrected input signal and a set point value; and
an output device disposed to receive the output signal and adjust the operating parameter in the water treatment system based on the output signal.

11. The system of claim 10, wherein the operating parameter corresponds to an oxidation reduction potential of water in the water treatment system.

12. The system of claim 10, wherein the electrochemical sensor comprises a membrane covered electrode.

13. The system of claim 12, wherein the electrochemical sensor comprises a free or total chlorine probe.

14. The system of claim 12, wherein the electrochemical sensor comprises a redox probe.

15. The system of claim 10, wherein the output signal generated by the controller is based on a rate of change in the input signal.

16. The system of claim 15, wherein the output signal is reduced as a rate of change of input signal is reduced.

17. The system of claim 16, wherein the controller applies a reduction factor to the output signal if the rate of change of input signal is below a threshold value.

18. The system of claim 10, wherein the electrochemical sensor is characterized by a T90 response time of less than about 60 seconds.

19. A membrane based electrochemical analyzer having a T90 response time of less than about 60 seconds.

20. The electrochemical analyzer of claim 19, configured to reduce an applied correction factor as the analyzer approaches a residual value.
